(19) United States
(12) Patent Application Publication
(10) Pub. No.: US 2025/0270448 A1
(43) Pub. Date: Aug. 28, 2025

(54) DISPERSANT FOR GRAPHITE AND GRAPHENE AND APPLICATIONS THEREOF

(71) Applicants: CHIANG, Fung-Ming, Taipei City (TW); TAIWAN SURFACTANT CORPORATION, Taipei City (TW)

(72) Inventor: Fung-Ming CHIANG, Taipei City (TW)

(21) Appl. No.: 18/985,566

(22) Filed: Dec. 18, 2024

(30) Foreign Application Priority Data
Dec. 27, 2023 (TW) 112150994

(51) Int. Cl. C09K 23/00; C01B 32/194; C01B 32/21; C04B 14/02; C04B 24/16; C04B 24/32; C04B 40/00; C04B 103/40; C09D 7/45; C09D 7/61; C09D 7/63; C09D 7/65; C09K 23/10; C09K 23/42; G21F 9/12

(52) U.S. Cl. CPC C09K 23/018; C01B 32/194; C01B 32/21; C04B 14/024; C04B 24/16; C04B 24/32; C04B 40/0039; C09D 7/45; C09D 7/61; C09D 7/63; C09D 7/65; C09K 23/10; C09K 23/42; G21F 9/12; C04B 2103/408

(57) ABSTRACT

The present invention relates to a dispersant for graphite and graphene and its application. The composition is a synergistic combination of alkyl sulfosuccinate and polyalkylene glycol. Appropriate adding amount thereof can quickly and easily disperse graphite and graphene in the medium, improve its dispersion uniformity and stability, delay its sedimentation, and inhibit its re-accumulation. Furthermore, the present invention can apply graphite and graphene to other media besides non-water-based or organic solvents. The composition of the present invention does not contain flammable volatile chemicals, any fluorine-, silicon- or phosphorus-based compounds, or any aromatic substances. The present invention can not only reduce environmental pollution but also improve the operational safety of relevant personnel.

### CROSS-REFERENCE TO RELATED APPLICATIONS

This application claims the benefits of the Taiwan Patent Application Serial Number 112150994, filed on Dec. 27, 2023, the subject matter of which is incorporated herein by reference.

### BACKGROUND OF THE INVENTION

### Field

The present invention relates to a dispersant for graphite and graphene and applications thereof.

### Description of Related Art

Graphite is an allotrope of carbon, which has high chemical stability, strong acid and alkali resistance, fire resistance, good electrical conductivity and thermal conductivity. Since graphite is a non-polar solid material, it is difficult to disperse in water, which limits its application. To make graphite evenly dispersed in water, it is desirable to provide an appropriate and efficient surfactant composition to improve the wettability, dispersion and permeability of water to graphite to expand the applications of graphite (including natural flake graphite, spherical graphite, expanded graphite, etc.) in industrial water-based applications.

At present, the common production methods of graphene are mechanical exfoliation, liquid phase exfoliation (including redox method and solvent exfoliation), and chemical vapor deposition (CVD). Although the mechanical exfoliation can prepare high-quality graphene, it has the disadvantages of low yield and high cost, as well as the problem of being difficult to disperse and easy to aggregate, and so it does not meet the requirements of industrialization and large-scale production. Although the chemical vapor deposition can meet the requirements for large-scale production of high-quality graphene, the cost thereof is high, and the process thereof is complex. Although the liquid-phase ultrasonic exfoliation is low-cost and easy to implement, and may become the best method for preparing graphene, the disadvantage of the oxidation-reduction method is that large-scale production may easily cause waste liquid pollution, and the prepared graphene has certain defects, resulting in the loss of some electrical properties of graphene, limiting the application of graphene. Although high-quality graphene can be prepared by general solvent stripping methods currently, the disadvantage thereof is that toxic solvents that are difficult to remove, such as N-methyl-2-pyrrolidone (NMP) or dimethylformamide (DMF), must be used to form graphite dispersions, and then ultrasonic peeling is performed. If water with high-efficiency dispersant can be used to form a graphite dispersion solution, and then perform ultrasonic peeling, not only the use of toxic solvents that are difficult to remove can be avoided, but the yield of graphene can also be increased by increasing the concentration of graphite in the dispersed aqueous solution.

Since graphene has a planar conjugated structure composed of sp² hybridized carbon atoms, there are very strong n-n interactions and van der Waals forces between its sheets, and it has a large specific surface area, resulting in extremely poor dispersion. Graphene has a wide range of applications, such as conductive materials, antistatic materials, thermal conductivity, heat dissipation materials, flame retardant materials, anti-corrosion coatings, waterproof coatings, reinforced cement, asphalt and antibacterial materials, etc. Graphene sheets are not easy to disperse evenly in the application medium, and are easy to aggregate, stack and agglomerate. Even after being dispersed, they may aggregate in a short time. The re-aggregation will prevent graphene from showing its unique and excellent physical properties, such as conductivity, heat dissipation, flame retardancy, anti-corrosion, waterproofing, strengthening, adsorption, antibacterial, etc.

The most common problem faced in the application of graphene is how to disperse the graphene sheets evenly and prevent the graphene sheets from aggregating. This has always been the most technical bottleneck that needs to be solved in the industry. In addition, during the application preparation process, graphene is dispersed in water or non-toxic organic solvents due to the requirement for operability and processability. Traditional commercial surfactants, such as sodium dodecylbenzene sulfonate (SDBS), cetyltrimethylammonium bromide (CTAB), phenyl-polyethylene glycol (Triton-X-100), poly Sorbitol ester 80 (Tween 80) and polymer stabilizers (for example, polyvinylpyrrolidone (PVP), polystyrene sodium sulfonate (PSS), polydimethyldiallylammonium chloride (PDDA), etc.) can play a certain role in dispersing and stabilizing graphene. However, there are often problems such as large using amount of dispersant and low concentration of graphene. Excessive dispersant using amount and too low graphene concentration are unfavorable factors for constructing composite materials. The biggest challenge currently that graphene application development technology faces is how to find an appropriate and efficient graphene dispersant.

TW201620607A discloses a graphene dispersant, which includes aniline oligomers or aniline oligomer derivatives, and the aniline oligomers or aniline oligomer derivatives are electroactive polymers. CN105645388A discloses a graphene dispersant which includes electroactive aniline oligomers and/or derivatives thereof. TW202311355A discloses a use of a polyalkylene oxide having at least one aromatic group as a dispersant for graphene materials. However, the disclosed dispersants contain benzene-based substances, which have poor biodegradability. TW201711959A discloses a graphene dispersion, which is a dispersion in which graphene is dispersed in a solvent containing more than 50 wt % of N-methyl-2-pyrrolidone (NMP, flash point 86.1° C.), and a large amount of highly toxic flammable organic solvents is used.

Graphene oxide (GO) sheets are the product of graphite powder after chemical oxidation exfoliation. Graphene oxide has long been regarded as a hydrophilic substance due to its superior dispersion in water. However, because the mechanical properties of graphene oxide are determined by the degree of oxidation and thickness, there are still some shortcomings in its application. Because structural defects will affect its physical properties, the applicability of graphene oxide is still limited.

Current graphene research has involved applications in drug delivery carriers, tumor treatment, antibacterial sterilization, and artificial implanted devices. The interaction of graphene with pathogens is largely influenced by the physicochemical properties of the graphene, such as surface-related properties, shape, size, dispersion, functionalization, and electronic structure. Graphene oxide has oxygen-containing functional groups, can be dispersed in water, and is easily dispersed in many solvents, so it is widely used in biomedicine. However, the oxygen functional groups of graphene oxide belong to reactive oxygen species (ROS), which can cause oxidative stress and may lead to the dominant mechanism for inducing pathological changes. The use of easily dispersible pristine graphene can reduce the induction of these pathological changes.

Neutralizing radioactive waste at nuclear power plants is one of the major economic and scientific problems of the 21st century. Graphene can absorb radioactive materials in nuclear power plant wastewater and form blocks. These blocks can be removed from the liquid and then recycled or burned, thereby improving the storage method of radioactive waste, reducing its quantity, and avoiding the risk of leakage. According to preliminary calculations by experts in the field, each kilogram of graphene can purify about 25 grams of radioactive materials. The current relevant research is to use graphene oxide that is easier to disperse in water. However, because graphene oxide contains structural defects caused by the oxidation process, it has a negative impact on its adsorption. In addition, its manufacturing and production will cause environmental chemical pollution. Therefore, it is desirable to provide a dispersant that can easily disperse the pristine graphene in water to facilitate more effective treatment of radioactive waste liquids from nuclear power plants.

Currently, graphite and graphene are not easy to form dispersed aqueous solution due to their physical properties. In the case of graphene, generally only graphene oxide aqueous dispersed solution can be produced, which results in the application range of graphite and graphene being greatly restricted. Therefore, it is desirable to provide a dispersant for graphite and graphene that can be used to produce solid or liquid graphite materials (powder, flake, spherical, and expanded graphite), graphene materials, and related nanocarbon materials (such as nanotubes, nanosheets, quantum dots, and sponges) that are easily dispersed in water, to expand the possible application range of graphite and graphene.

Therefore, an object of the present invention is to provide a dispersant for graphite and graphene and a method for dispersing graphite and graphene. By using the dispersant, graphite, graphene, or a combination thereof can be evenly dispersed, thereby realizing applications thereof in various fields. In particular, the present invention provides a dispersant without aromatic substances and toxic and flammable organic solvents, which can quickly, evenly and stably disperse graphite, graphene or a combination thereof in water to obtain a dispersed solution containing graphite, graphene or a combination thereof with high concentration. This is an urgent problem that needs to be overcome in various industrial applications of graphite, graphene, or a combination thereof today.

### SUMMARY OF THE INVENTION

In view of this, the present invention provides a dispersant for graphite and graphene and a method for dispersing graphite and graphene, wherein the dispersant does not contain toxic substances, volatile chemicals/organic solvents, any fluorine-, silicone- or phosphorus-based compounds or any aromatic compounds or is environmentally friendly and safe for humans and animals. The dispersant has excellent dispersibility for graphite, graphene, or a combination thereof, allowing graphite, graphene, or a combination thereof to be evenly dispersed in water, improving the wettability, dispersion, and permeability of water for graphite, graphene, or a combination thereof to expand industrial water-based applications.

To achieve the aforesaid objects, one aspect of the present invention provides a dispersant for graphite and graphene, which comprises: alkyl sulfosuccinate; and polyalkylene glycol, wherein a weight ratio of the alkyl sulfosuccinate to the polyalkylene glycol ranges from 1:99 to 99:1, for example, from 1:9 to 9:1, from 2:8 to 8:2 or from 3:7 to 7:3, but the present invention is not limited thereto.

In the dispersant for graphite and graphene the present invention, the alkyl sulfosuccinate may be mono-alkyl sulfosuccinate, di-alkyl sulfosuccinate, multi-alkyl sulfosuccinate or a combination thereof. Herein, the mono-alkyl sulfosuccinate may have C₁₋₁₈ alkyl, preferably C₄₋₁₈ alkyl, more preferably C₄₋₁₂ alkyl and most preferably C₆₋₈ alkyl. The di-alkyl sulfosuccinate may have two identical or different C₁₋₁₈ alkyl, preferably C₄₋₁₈ alkyl, more preferably C₄₋₁₂ alkyl and most preferably C₆₋₈ alkyl. The multi-alkyl sulfosuccinate may have multiple identical or different C₁₋₁₈ alkyl, preferably C₄₋₁₈ alkyl, more preferably C₄₋₁₂ alkyl and most preferably C₆₋₈ alkyl. However, the present invention is not limited thereto.

In the dispersant for graphite and graphene of the present invention, the alkyl sulfosuccinate may be represented by the following formula:

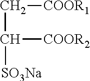

wherein each R₁ and R₂ may respectively is alkyl, but the present invention is not limited thereto. In addition, each R₁ and R₂ may respectively is C₁₋₁₈ alkyl, preferably C₄₋₁₈ alkyl, more preferably C₄₋₁₂ alkyl and most preferably C₆₋₈ alkyl, but the present invention is not limited thereto. In addition, R₁ and R₂ may be the same or different alkyl, and more preferably the same alkyl.

In the present invention, the “alkyl” refers to linear or branched alkyl, and for example includes linear or branched C₁₋₁₈ alkyl, C₄₋₁₈ alkyl, C₄₋₁₂ alkyl or C₆₋₈ alkyl; and the specific examples thereof include, but are not limited to hexyl, heptyl or octyl.

In the dispersant for graphite and graphene of the present invention, polyalkylene glycol may be represented by the following formula:

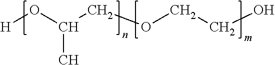

wherein a ratio of n to m may be between 1 and 10; and a molecular weight of the polyalkylene glycol may be between 500 and 6000, for example, between 800 and 6000, between 1000 and 5000, between 2000 and 5000 or between 2500 and 5000, but the present invention is not limited thereto.

In the dispersant for graphite and graphene of the present invention, an adding amount of the dispersant for graphite and graphene in a medium may be 0.01 wt % to 10 wt % of a weight of the medium, for example, 0.05 wt % to 10 wt %, 0.1 wt % to 10 wt %, 0.1 wt % to 8 wt %, 0.1 wt % to 5 wt % or 0.1 wt % to 3 wt % of the weight of the medium, but the present invention is not limited thereto.

In the dispersant for graphite and graphene of the present invention, the medium may be water, an organic solvent, a resin, latex, a plastic, a paint, concrete, ceramics, asphalt, oil, a metal material, or a combination thereof, but the present invention is not limited thereto.

In the dispersant for graphite and graphene of the present invention, the dispersant for graphite and graphene may be used to produce solid or liquid graphite materials (powder, flake, spherical, and expanded graphite), graphene materials, and related nanocarbon materials (such as nanotubes, nanosheets, quantum dots, and sponges) that are easily dispersed in water, but the present invention is not limited thereto.

In the dispersant for graphite and graphene of the present invention, the dispersant for graphite and graphene may not contain any flammable organic solvents, any fluorine-, silicon- or phosphorus-based compounds or any aromatic compounds, but the present invention is not limited thereto.

Another aspect of the present invention provides a method for dispersing graphite and graphene, which comprises the following steps: (a) formulating the aforesaid dispersant for graphite and graphene; and (b) mixing the dispersant for graphite and graphene obtained in the step (a) with a carbon material to disperse the carbon material, wherein the carbon material is graphite, graphene, or a combination thereof.

In the method of the present invention, graphite, graphene, or a combination thereof may be dispersed by liquid phase exfoliation or mechanical exfoliation, but the present invention is not limited thereto.

In the method of the present invention, graphite, graphene, or a combination thereof may be used in electrical conductivity, heat dissipation/energy storage, flame retardant, anti-corrosion, waterproof, reinforcement, adsorption, antibacterial or a combination thereof, but the present invention is not limited thereto.

In the method of the present invention, graphite, graphene, or a combination thereof may be used in biomedical liquids, but the present invention is not limited thereto.

In the method of the present invention, graphite, graphene, or a combination thereof may be used in treatment of radioactive discharge liquids from nuclear power plants, but the present invention is not limited thereto.

In the method of the present invention, the aforesaid dispersant for graphite and graphene may be applied by mixing, dispersing, spraying, coating, extruding, ball milling or a combination thereof, but the present invention is not limited thereto.

Other novel features, advantages and objects of the disclosure will become more apparent from the following detailed description when taken in conjunction with the accompanying drawings.

### DETAILED DESCRIPTION OF THE INVENTION

Different embodiments of the present invention are provided below. These embodiments are used to illustrate the technical content of the present invention but are not used to limit the claims of the present invention. A feature of one embodiment can be applied to other embodiments through appropriate modification, substitution, combination, and separation.

In the present specification, unless otherwise specified, the feature A “or” or “and/or” the feature B means that the feature A exists alone, the feature B exists alone, or the features A and B exist simultaneously. The feature A “and” the feature B means that the features A and B exist at the same time. The “include”, “comprise”, “have” and “contain” mean including but not limited thereto.

In addition, in the present specification, “preferably” or “more preferably” is used to describe optional or additional elements or features, that is, these elements or features are not necessary and may be omitted.

Furthermore, in the present specification, unless otherwise specified, a numerical value may encompass a range of ±10% of the numerical value, in particular a range of ±5% of the numerical value. Unless otherwise specified, a numerical range is composed of sub-ranges defined by a smaller endpoint, a smaller quartile, a median, a larger quartile, and a larger endpoint.

The dispersant for graphite and graphene of the present invention comprises alkyl sulfosuccinate; and polyalkylene glycol, wherein a weight ratio of the alkyl sulfosuccinate to the polyalkylene glycol ranges from 1:99 to 99:1. When applying the above dispersant for graphite and graphene, water or organic solvents may be used to dilute it to an appropriate concentration, or the dispersant can be directly used without dilution. The dispersant can be evenly dispersed in the medium of the desired application in various ways.

The method for dispersing graphite and graphene comprises the following steps: (a) formulating the aforesaid dispersant for graphite and graphene; and (b) mixing the dispersant for graphite and graphene obtained in the step (a) with a carbon material to disperse the carbon material, wherein the carbon material is graphite, graphene, or a combination thereof.

The specific embodiments of the dispersant for graphite and graphene provided by the present invention and the dispersed material that the dispersant is applied thereto are as follows.

Embodiment 1 - dispersed material: high
purity graphite powders (300 mesh)

| Medium | Pure water | |
|---|---|---|
| Alkyl sulfosuccinate (branched C₁₀ alkyl) | Mix weight ratio | |
| Polyalkylene glycol (n:m = 1:1, molecular | 2:1 | |
| weight 4000 mol/g) | | |
| The adding amount of the dispersant for graphite and | 1 | wt % |
| graphene of Embodiment 1 in the medium | | |
| The concentration of high purity graphite | 2 | mg/ml |

| | |
|---|---|
| powders in the medium | |
| Adding method | Stirring evenly |
| Time to start layering/time for complete settling (min) | |
| Blank (without the dispersant for graphite | 5 min/30 min |
| and graphene of Embodiment 1) | |
| Adding the dispersant for graphite and graphene of | 30 min/120 min |
| Embodiment 1 | |

Conclusion: After adding the dispersant for graphite and graphene of Embodiment 1 of the present invention, the dispersion uniformity is immediately significantly improved, and the settling time is significantly delayed.

Embodiment 2 - dispersed material:
graphite flakes (99.9%, 40-60 mesh)

| | |
|---|---|
| Medium | Pure water |
| Alkyl sulfosuccinate (linear C₁₀ alkyl) | Mix weight ratio |
| Polyalkylene glycol (n:m = 1:1, molecular | 3:1 |
| weight 4000 mol/g | |
| The adding amount of the dispersant for graphite and | 0.1 g/50 g |
| graphene of Embodiment 2 in the medium | |
| The concentration of graphite flakes in the medium | 1.0 g/50 g |
| Adding method | Stirring evenly |
| Time to start layering/time for complete settling (min) | |
| Blank (without the dispersant for graphite | 0.1 min/0.5 min |
| and graphene of Embodiment 2) | |
| Adding the dispersant for graphite and graphene of | 0.5 min/90 min |
| Embodiment 2 | |

Conclusion: After adding the dispersant for graphite and graphene of Embodiment 2 of the present invention, the dispersion uniformity is immediately significantly improved and the settling time is significantly delayed.

Embodiment 3 - dispersed material: expanded
graphite powders (325 mesh)

| | |
|---|---|
| Medium | Pure water |
| Alkyl sulfosuccinate (linear C₈ alkyl) | Mix weight ratio |
| Polyalkylene glycol (n:m = 1:1, molecular | 1:1 |
| weight 4000 mol/g) | |
| The adding amount of the dispersant for graphite | 0.1 g/50 g |
| and graphene of Embodiment 3 in the medium | |
| The concentration of expanded graphite | 0.5 g/50 g |
| powders in the medium in the medium | |
| Adding method | Stirring evenly |
| Time to start layering/time for | |
| complete settling (min) | |
| Blank (without the dispersant for graphite | 0.25 min/2 min |
| and graphene of Embodiment 3) | |
| Adding the dispersant for graphite and graphene of | 60 min/120 min |
| Embodiment 3 | |

Conclusion: After adding the dispersant for graphite and graphene of Embodiment 3 of the present invention, the dispersion uniformity is immediately significantly improved and the settling time is significantly delayed.

Embodiment 4 - dispersed material: spherical graphite (8 μm)

| | |
|---|---|
| Medium | Pure water |
| Alkyl sulfosuccinate (branched C₁₀ alkyl) | Mix weight ratio |
| Polyalkylene glycol (n:m = 1:1, molecular | 3:1 |
| weight 3000 mol/g) | |
| The adding amount of the dispersant for graphite and | 0.1 g/50 g |
| graphene of Embodiment 4 in the medium | |
| The concentration of spherical graphite | 0.5 g/50 g |
| in the medium in the medium | |
| Adding method | Stirring evenly |
| Time to start layering/time for complete settling (min) | |
| Blank (without the dispersant for graphite | 5 min/50 min |
| and graphene of Embodiment 4) | |
| Adding the dispersant for graphite and graphene of | 35 min/90 min |
| Embodiment 4 | |

Conclusion: After adding the dispersant for graphite and graphene of Embodiment 4 of the present invention, the dispersion uniformity is immediately significantly improved and the settling time is significantly delayed.

Embodiment 5 - dispersed material:
high purity graphene (10000 mesh)

| Medium | Pure water | |
|---|---|---|
| Alkyl sulfosuccinate (linear C₁₀ alkyl) | Mix weight ratio | |
| Polyalkylene glycol (n:m = 2:1, molecular | 1:1 | |
| weight 4000 mol/g) | | |
| The adding amount of the dispersant for graphite and | 1 | wt % |
| graphene of Embodiment 5 in the medium | | |
| The concentration of high purity graphene | 2.5 | mg/ml |

| | |
|---|---|
| in the medium in the medium | |
| Adding method | Stirring evenly |
| Time to start layering/time for complete settling (min) | |
| Blank (without the dispersant for graphite | 1 min/30 min |
| and graphene of Embodiment 5) | |
| Adding the dispersant for graphite and graphene of | 90 min/180 min |
| Embodiment 5 | |

Conclusion: After adding the dispersant for graphite and graphene of Embodiment 5 of the present invention, the dispersion uniformity is immediately significantly improved, and the settling time is significantly delayed.

Embodiment 6 - dispersed material: high
purity graphene (>99%, 8 μm)

| | |
|---|---|
| Medium | Pure water |
| Alkyl sulfosuccinate (branched C₁₂ alkyl) | Mix weight ratio |
| Polyalkylene glycol (n:m = 2:1, molecular | 3:1 |
| weight 4000 mol/g) | |
| The adding amount of the dispersant for graphite and | 1 wt % |
| graphene of Embodiment 6 in the medium | |
| The concentration of high purity graphene | 0.25 g/50 g |
| (>99%) in the medium in the medium | |
| Adding method | Stirring evenly |
| Time to start layering/time for complete settling (min) | |
| Blank (without the dispersant for graphite | 0.5 min/3 min |
| and graphene of Embodiment 6) | |
| Adding the dispersant for graphite and graphene of | 50 min/180 min |
| Embodiment 6 | |

Conclusion: After adding the dispersant for graphite and graphene of Embodiment 6 of the present invention, the dispersion uniformity is immediately significantly improved, and the settling time is significantly delayed.

Embodiment 7 - dispersed material: high purity graphene
dispersed in aqueous solution of water-based polyurea

| | |
|---|---|
| Medium (25 g water-based polyurea + 25 g water) | Aqueous solution |
| | of water-based |
| | polyuria |
| Alkyl sulfosuccinate (linear C₁₀ alkyl) | Mix weight ratio |
| Polyalkylene glycol (n:m = 3:1, molecular | 3:1 |
| weight 1000 mol/g) | |
| The adding amount of the dispersant for graphite and | 0.2 wt % |
| graphene of Embodiment 7 in the medium | |
| The concentration of high purity graphene | 0.1 g/50 g |
| (>99%) in the medium | |
| Adding method | Stirring evenly |

Conclusion: Polyurea is mainly used in four major areas including waterproofing, anti-corrosion, anti-abrasion, and surface decoration. Evenly dispersing high-purity graphene in polyurea can improve its waterproof mechanical strength. After adding the dispersant for graphite and graphene of Embodiment 7 of the present invention, the viscosity of the aqueous solution of water-based polyurea is immediately significantly reduced, the permeability is improved, the dispersion is uniform, and the coating is smooth. The thickness of the coating formed by the aqueous solution of water-based polyurea/graphene added with the dispersant for graphite and graphene of Embodiment 7 of the present invention is ⅓ of the thickness formed by the aqueous solution of water-based polyurea/graphene without the dispersant for graphite and graphene of Embodiment 7.

Embodiment 8 - dispersed material: high purity graphene
dispersed in aqueous solution of vermiculite powders

| | |
|---|---|
| Medium (5 g vermiculite powders + 25 g water) | Aqueous solution |
| | of vermiculite |
| | powders |
| Alkyl sulfosuccinate (linear C₁₂ alkyl) | Mix weight ratio |
| Polyalkylene glycol (n:m = 1:1, molecular | 2:1 |
| weight 3000 mol/g) | |
| The adding amount of the dispersant for graphite and | 0.3 g/30 g |
| graphene of Embodiment 8 in the medium | |
| The concentration of high purity graphene | 0.1 g/30 g |
| in the medium | |
| Adding method | Stirring evenly |

Conclusion: Vermiculite powder has good thermal insulation. The melting point thereof is as high as 1400° C. and the density thereof is as low as 0.9 g/cm³, so vermiculite powder has important applications in fireproof and thermal insulation materials. Evenly dispersing high-purity graphene in vermiculite can improve its flame-retardant effect. After adding the dispersant for graphite and graphene of Embodiment 8 of the present invention, the viscosity of the aqueous solution of vermiculite powders is immediately significantly reduced, the permeability is improved, the dispersion is uniform, and the coating is smooth. The thickness of the coating formed by the aqueous solution of vermiculite powders/graphene added with the dispersant for graphite and graphene of Embodiment 8 of the present invention is ⅓ of the thickness formed by the aqueous solution of vermiculite powders/graphene without the dispersant for graphite and graphene of Embodiment 8.

Embodiment 9 - dispersed material: high purity graphene
dispersed in aqueous solution of sodium lignosulfonate

| | |
|---|---|
| Medium (20 g sodium lignosulfonate + 20 g water) | Aqueous solution |
| | of sodium |
| | lignosulfonate |
| Alkyl sulfosuccinate (linear C₈ alkyl) | Mix weight ratio |
| Polyalkylene glycol (n:m = 1:1, molecular | 3:1 |
| weight 3000 mol/g) | |
| The adding amount of the dispersant for graphite and | 0.4 g/30 g |
| graphene of Embodiment 9 in the medium | |
| The concentration of high purity | 0.4 g/30 g |
| (>99%) graphene in the medium | |
| Adding method | Stirring evenly |

Conclusion: Sodium lignosulfonate can be used as an admixture for concrete and as a high-efficiency concrete water-reducing agent. Sodium lignosulfonate has excellent properties and is suitable for projects such as culverts, dams, reservoirs, airports, and highways. Evenly dispersing high-purity graphene in sodium lignosulfonate can increase the strength of concrete. After adding the dispersant for graphite and graphene of Embodiment 9 of the present invention, the viscosity of the aqueous solution of sodium lignosulfonate is immediately significantly reduced, the permeability is improved, the dispersion is uniform, and the coating is smooth. The thickness of the coating formed by the aqueous solution of sodium lignosulfonate/graphene added with the dispersant for graphite and graphene of Embodiment 9 of the present invention is ⅓ of the thickness formed by the aqueous solution of sodium lignosulfonate/graphene without the dispersant for graphite and graphene of Embodiment 9. In addition, after adding the aforesaid dispersant for graphite and graphene of the present invention, the usage amount of sodium lignosulfonate can be reduced.

Compared with other technologies, the dispersant for graphite and graphene provided by the present invention has the following advantages.
1. It does not contain any organic solvents with flammable or volatile compounds and is not dangerous goods.
2. It does not contain any toxic substances and will not harm the health of humans and animals.
3. It does not contain any aromatic compounds and has excellent operational safety.
4. It does not contain any fluorine-, silicon- or phosphorus-based compounds, and is biodegradable to avoid environmental pollution.
5. Graphite, graphene or a combination thereof can be easily dispersed in aqueous solution, which has the characteristics of expanding the industrial operability and application range of graphite, graphene, or a combination thereof.
6. The low using amount can improve the economical application of graphite and graphene in industry.

In conclusion, the dispersant for graphite and graphene of the present invention is characterized by small using amount, quick effect, high convenience of implementation, wide application, safety and non-toxicity, environmental friendliness, and high economic efficiency.

Although the present disclosure has been explained in relation to its embodiment, it is to be understood that many other possible modifications and variations can be made without departing from the spirit and scope of the disclosure as hereinafter claimed.

1. A dispersant for graphite and graphene, comprising:
alkyl sulfosuccinate; and
polyalkylene glycol,
wherein a weight ratio of the alkyl sulfosuccinate to the polyalkylene glycol ranges from 1:99 to 99:1.

2. The dispersant of claim 1, wherein the alkyl sulfosuccinate is mono-alkyl sulfosuccinate, di-alkyl sulfosuccinate, multi-alkyl sulfosuccinate or a combination thereof.

3. The dispersant of claim 1, wherein the alkyl sulfosuccinate is represented by the following formula: 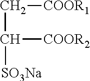
wherein each R₁ and R₂ respectively is alkyl.

4. The dispersant of claim 3, wherein each R₁ and R₂ respectively is C₄₋₁₈ alkyl.

5. The dispersant of claim 1, wherein the polyalkylene glycol is represented by the following formula: 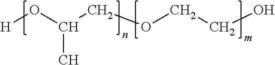
wherein a ratio of n to m is between 1 and 10, and a molecular weight of the polyalkylene glycol is between 500 and 6000.

6. The dispersant of claim 1, wherein the weight ratio of the alkyl sulfosuccinate to the polyalkylene glycol ranges from 1:9 to 9:1.

7. The dispersant of claim 1, wherein an adding amount of the dispersant in a medium is 0.01 wt % to 10 wt % of a weight of the medium.

8. The dispersant of claim 7, wherein the medium is water, an organic solvent, a resin, latex, a plastic, a paint, concrete, ceramics, asphalt, oil, a metal material or a combination thereof.

9. The dispersant of claim 1, wherein the dispersant does not contain any flammable organic solvents.

10. The dispersant of claim 1, wherein the dispersant does not contain any fluorine-, silicon- or phosphorus-based compounds.

11. The dispersant of claim 1, wherein the dispersant does not contain any aromatic compounds.

12. The dispersant of claim 1, wherein the dispersant is used to prepare a solid or liquid graphite material, a graphene material and a related nanocarbon material that is easily dispersed in water.

13. A method for dispersing graphite and graphene, comprising the following steps:
(a) formulating a dispersant for graphite and graphene, comprising:
alkyl sulfosuccinate; and
polyalkylene glycol,
wherein a weight ratio of the alkyl sulfosuccinate to the polyalkylene glycol ranges from 1:99 to 99:1; and
(b) mixing the dispersant for graphite and graphene with a carbon material to disperse the carbon material, wherein the carbon material is graphite, graphene or a combination thereof.

14. The method of claim 13, wherein the graphite, the graphene or the combination thereof is dispersed by liquid phase exfoliation or mechanical exfoliation.

15. The method of claim 13, wherein the graphite, the graphene or the combination thereof is used in electrical conductivity, heat dissipation/energy storage, flame retardant, anti-corrosion, waterproof, reinforcement, adsorption, antibacterial or a combination thereof.

16. The method of claim 13, wherein the graphite, the graphene or the combination thereof is used in biomedical liquids.

17. The method of claim 13, wherein the graphite, the graphene or the combination thereof is used in treatment of radioactive discharge liquids from nuclear power plants.

18. The method of claim 13, wherein the dispersant is applied by mixing, dispersing, spraying, coating, extruding, ball milling or a combination thereof.
